(19) United States
(12) Patent Application Publication
(10) Pub. No.: US 2008/0122730 A1
(43) Pub. Date: May 29, 2008

(54) Antenna seat

(76) Inventor: Kao-Shen Lin, Taipei Hsien (TW)

Correspondence Address: KAO-SHEN LIN, 235 Chung - Ho, Box 8-24, Taipei, omitted

(21) Appl. No.: 11/447,750

(22) Filed: Jun. 7, 2006

(51) Int. Cl. H01Q 1/50; H01Q 1/12

(52) U.S. Cl. 343/878; 343/906

(57) ABSTRACT

An antenna seat comprises a female joint having a connecting cylinder; an inner side of the connecting cylinder having a buckle ring; and a male joint having a tapered inner cylinder corresponding to the buckle ring; a left end of the tapered inner cylinder having a flange; an inner space of the tapered inner cylinder being formed with a terminal for receiving one end of an antenna, wherein the tapered inner cylinder has a tapered shape so that as it is inserted into the connecting cylinder of the female joint, the male joint will rotatably and tightly engage with the female joint. Thereby in another case, the female joint has a tapered inner cylinder near an opening of the female joint.

### FIELD OF THE INVENTION

The present invention relates to antenna seats, and in particular to an antenna seat. wherein the orientation of the antenna can be adjusted as desired. The antenna will not become loose. Moreover the antenna can be fixed to a desired orientation easily and the signal can be received clearly. Moreover in adjustment of the orientation, the male joint do not need to separate from the female joint. Further, the effect of the present invention is good and the use of the present invention is convenient.

### BACKGROUND OF THE INVENTION

With reference to FIG. 1, the use of prior art antenna seat is illustrated. It is illustrated that an antenna 2 is assembled to a router 1. A female joint 5 of the antenna 2 is installed in the router 1. Referring to FIG. 2, the female joint 5 has a connecting cylinder 8. A n inner side of the connecting cylinder 8 has a buckle ring 9. A male joint 4 is an inner cylinder 6. A top end of the inner cylinder 6 has a flange 7. An inner space of the male jointnal 10 for receiving an end 3 of an antenna 2.

The above mentioned structure can adjust the orientation of the antenna seat. However as the structure is used for a long time, the inner cylinder 6 and the connecting cylinder 8 will become loose and thus the antenna cannot be fixed to a desire orientation. Furthermore, it is possible that the signal cannot be well received, even the signals cannot be received.

With reference to FIG. 3, the female joint 5 has a connecting cylinder 8. An inner side of the connecting cylinder 8 has a groove 14. The male joint 4 has an inner cylinder 6. The inner cylinder 6 is installed with a block 13. An inner space of the male joint 4 is installed with a terminal 10 for receiving an antenna 3. In this structure, the antenna can be directly fixed without falling out. In adjustment of the orientation, the male joint 4 must separate from the female joint 5. After adjustment, the male joint 4 and female joint 5 are combined again. However this induces inconvenient in use.

Thereby disadvantage of the prior art are that although in the prior art, the orientation can be adjusted, however after a long time, the inner cylinder of the male joint will release from the connecting cylinder of the male joint. Thus the antenna can be fixed to a desired orientation. Moreover it is possible that the signal cannot be received well, even signals cannot be received. Thereby in adjustment, the male joint and the female joint must be separated and after adjustment, the male joint and female joint must be reassembled. The operation is complicated and inconvenient.

### SUMMARY OF THE INVENTION

Accordingly, the primary object of the present invention is to provide an antenna seat, wherein the orientation of the antenna can be adjusted as desired. The antenna will not become loose. Moreover the antenna can be fixed to a desired orientation easily and the signal can be received clearly. Moreover in adjustment of the orientation, the male joint do not need to separate from the female joint. Further, the effect of the present invention is good and the use of the present invention is convenient.

To achieve above objects, the present invention provides an antenna seat which comprises a female joint having a connecting cylinder; an inner side of the connecting cylinder having a buckle ring; and a male joint having a tapered inner cylinder corresponding to the buckle ring; a left end of the tapered inner cylinder having a flange; an inner space of the tapered inner cylinder being formed with a terminal for receiving one antenna of an antenna, wherein the tapered inner cylinder 11 has a tapered shape so that as it is inserted into the connecting cylinder of the female joint, the male joint will rotatably and tightly engage with the female joint; and wherein the female joint has a tapered inner cylinder.

### BRIEF DESCRIPTION OF THE DRAWINGS

FIG. 1 is a schematic view of the prior art antenna seat.

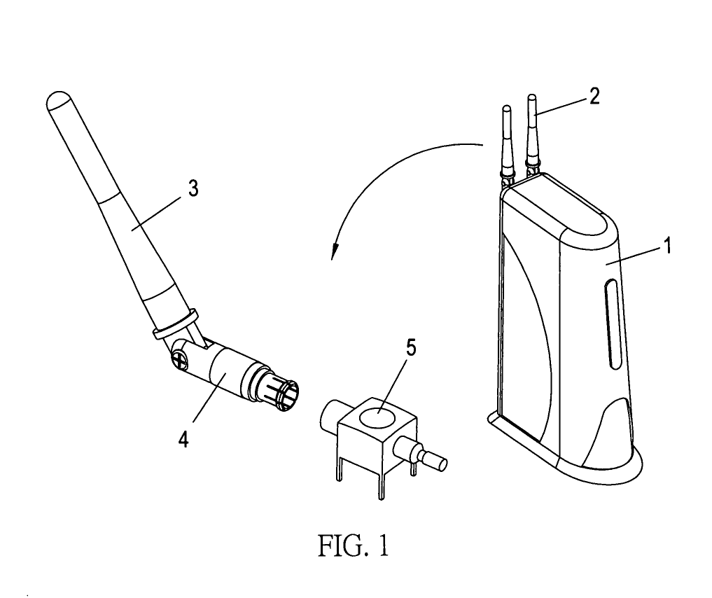

FIG. 2 is a schematic view of the prior art antenna seat.

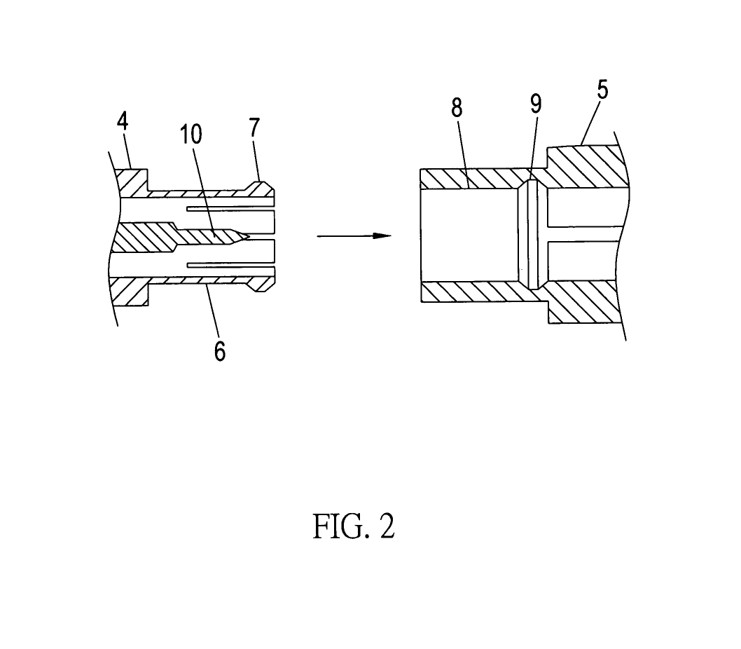

FIG. 3 is another schematic view of the prior art antenna seat.

FIG. 4 is a cross sectional view of the present invention.

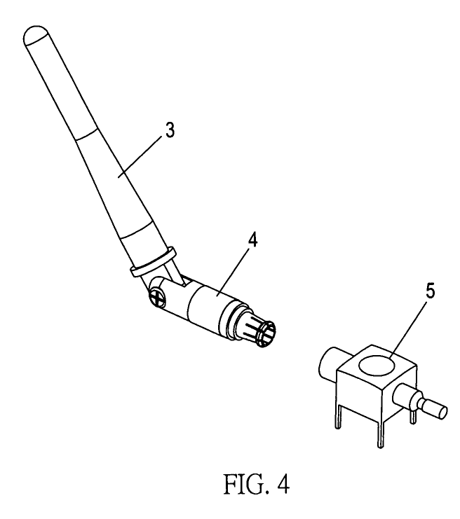

FIG. 5 is another cross sectional view of the present invention.

FIG. 6 is a further cross sectional view of the present invention.

FIG. 7 is a schematic view of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

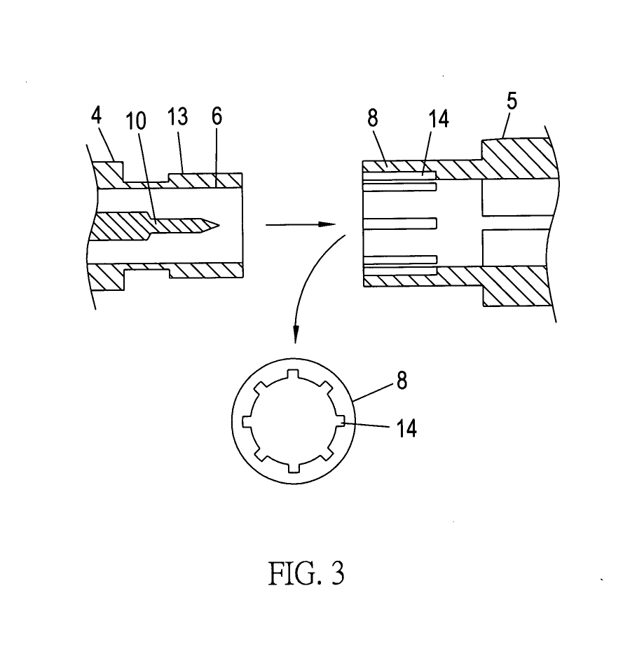

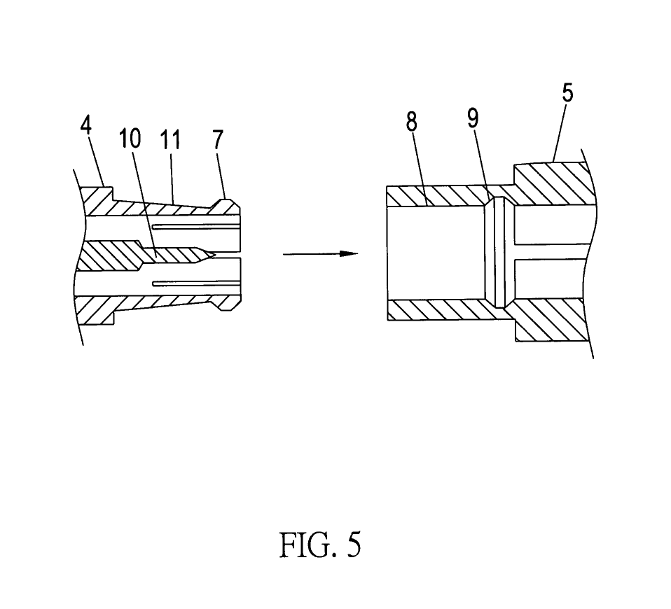

Referring to FIGS. 3, and 5, the structure of the present invention is illustrated. The present invention has the following elements.

A female joint 5 has a connecting cylinder 8. An inner side of the connecting cylinder 8 has a buckle ring 9.

A male joint 4 has a tapered inner cylinder 11 corresponding to the buckle ring 9. A left end of the tapered inner cylinder 11 has a flange 7. An inner space of the tapered inner cylinder 11 is formed with a terminal 10 for receiving one antenna 3 of an antenna. Because the tapered inner cylinder 11 has a tapered shape so that as it is inserted into the connecting cylinder 8 of the female joint 5, the male joint 4 will rotatably and tightly engage with the female joint 5.

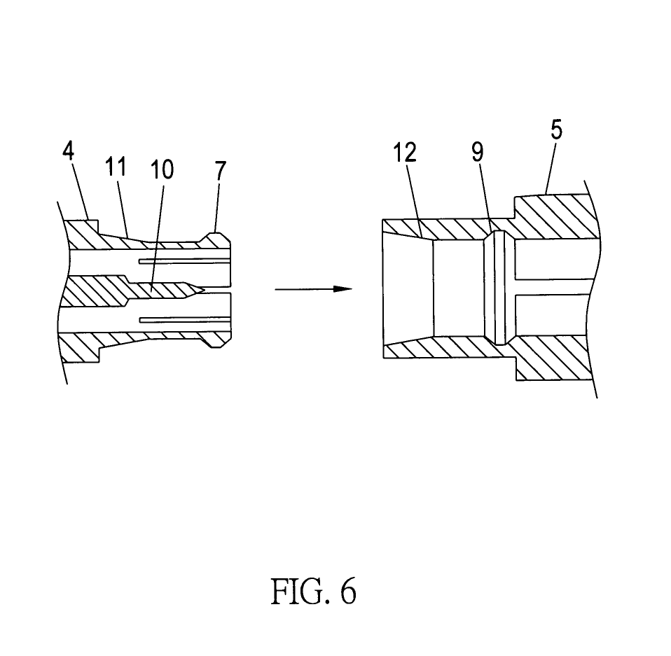

Referring to FIG. 6, another embodiment of the present invention is illustrated. A female joint 5 has a connecting cylinder 8. An inner side of the connecting cylinder 8 has a buckle ring 9.

A male joint 4 has a tapered inner cylinder 11 corresponding to the buckle ring 9. A left end of the tapered inner cylinder 11 has a flange 7. An inner space of the tapered inner cylinder 11 is formed with a terminal 10 for receiving one antenna 3 of an antenna. Because the tapered inner cylinder 11 has a tapered shape so that as it is inserted into the connecting cylinder 8 of the female joint 5, the male joint 4 will rotatably and tightly engage with the female joint 5. In this embodiment, the female joint 5 has a tapered inner cylinder 12

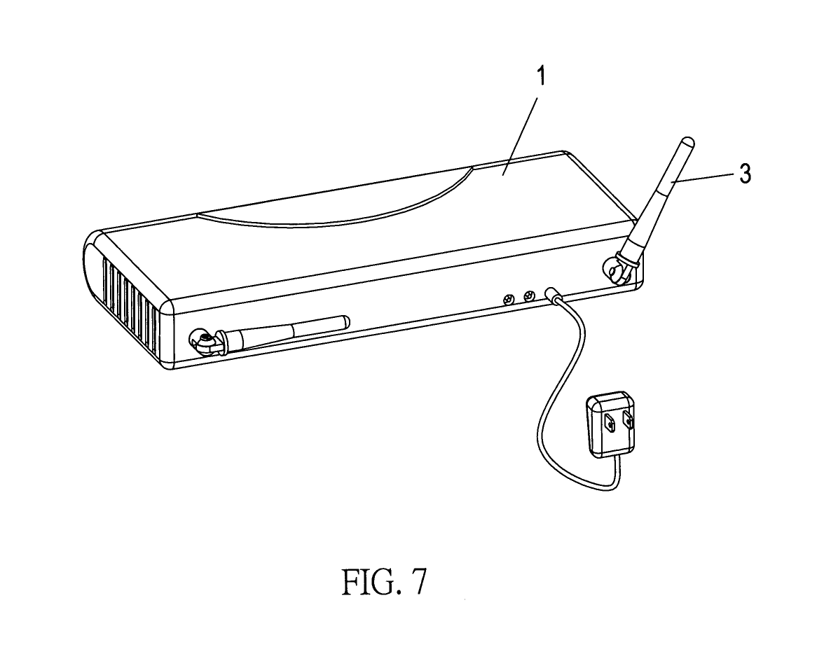

Referring to FIG. 7, it is illustrated that the antenna 3 is assembled to a router 1 and the antenna 3 can change its orientation as desired.

Advantages of the present invention are described herein. In the present invention, the orientation of the antenna can be adjusted as desired. The antenna will not become loose. Moreover the antenna can be fixed to a desired orientation easily and the signal can be received clearly.

Moreover in adjustment of the orientation, the male joint do not need to separate from the female joint. Further, the effect of the present invention is good and the use of the present invention is convenient.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An antenna seat comprising:
a female joint having a connecting cylinder; an inner side of the connecting cylinder having a buckle ring; and
a male joint having a tapered inner cylinder corresponding to the buckle ring; a left end of the tapered inner cylinder having a flange; an inner space of the tapered inner cylinder being formed with a terminal for receiving one end of an antenna, wherein the tapered inner cylinder has a tapered shape so that as it is inserted into the connecting cylinder of the female joint, the male joint will rotatably and tightly engage with the female joint.

2. An antenna seat comprising:
a female joint having a connecting cylinder; an inner side of the connecting cylinder having a buckle ring; and
a male joint having a tapered inner cylinder corresponding to the buckle ring; a left end of the tapered inner cylinder having a flange; an inner space of the tapered inner cylinder being formed with a terminal for receiving one end of an antenna, wherein the tapered inner cylinder has a tapered shape so that as it is inserted into the connecting cylinder of the female joint, the male joint will rotatably and tightly engage with the female joint; and
wherein the female joint has a tapered inner cylinder near an opening of the female joint.
